(19) United States
(12) Patent Application Publication
(10) Pub. No.: US 2005/0262763 A1
(43) Pub. Date: Dec. 1, 2005

(54) Tree injection device

(76) Inventors: Roger C. Funk, Streetsboro, OH (US); Brian L. Jeffers, Kent, OH (US); Gregory Mazur, Ravenna, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 11/121,608

(22) Filed: May 4, 2005

Related U.S. Application Data
(60) Provisional application No. 60/567,840, filed on May 4, 2004.

(51) Int. Cl. A01G 29/00

(52) U.S. Cl. 47/57.5

(57) ABSTRACT

A tree injection device including a piston slidably received within a cylinder to define a piston chamber and a rack chamber within the cylinder, a reservoir in fluid communication with the piston chamber, wherein a first check valve allows fluid to pass from the reservoir to the piston chamber while substantially preventing fluid from passing from the piston chamber to the reservoir, an injector in fluid communication with the piston chamber, the injector being adapted for insertion into a tree, wherein a second check valve allows fluid to pass from the piston chamber to the injector, while substantially preventing fluid from passing from the injector to the piston chamber and a motor operatively connected to the piston to advance the piston through the cylinder.

This application claims priority from U.S. Provisional Ser. No. 60/567,840 filed on May 4, 2004 contents of which are incorporated herein by reference.

### BACKGROUND

The present application relates to injection devices and, more particularly, to tree injection devices.

Tree injection devices typically are used to inject various fluids, such as growth retardants or regulators, fertilizers, fungicides, insecticides, herbicides, pesticides and the like, into the trunk of a tree. Ideally, the injection is made into the xylem cells of the outer growth rings of the tree. For example, a 10% solution of imidacloprid may be injected into the trunk of a tree to control the proliferation of the Asian Longhorn Beetle.

Tree injection devices typically operate at constant pressures and typically are available in two styles: low pressure tree injection devices that operate at a constant pressure of 10 psi or less and high pressure tree injection devices that operate at a constant pressure of 200 psi or more.

Such constant pressure injection devices present several problems. Low pressure tree injection devices may take up to four hours or more to inject a single dosage into a tree trunk. High pressure systems rapidly (i.e., almost instantaneously) injected the dosage into the trunk of a tree, which may result in vascular tissue damage and may impede the distribution of the dosage through the xylem cells of the tree. Furthermore, constant pressure tree injection devices do not take into account the fluctuations in resistance encountered when injecting fluids into trees.

Accordingly, there is a need for a variable pressure tree injection device capable of adapting to fluctuations in back pressure when injecting fluids into trees.

### SUMMARY

In one aspect, the tree injection device includes a piston slidably received within a cylinder to define a piston chamber and a rack chamber within the cylinder, a reservoir in fluid communication with the piston chamber, wherein a first check valve allows fluid to pass from the reservoir to the piston chamber while substantially preventing fluid from passing from the piston chamber to the reservoir, an injector in fluid communication with the piston chamber, the injector being adapted for insertion into a tree, wherein a second check valve allows fluid to pass from the piston chamber to the injector, while substantially preventing fluid from passing from the injector to the piston chamber and a drive motor assembly including a rack operatively connected to the piston to advance the piston through the cylinder, whereby movement of the piston by the drive motor provides a gradual increase in pressure such that cells of a tree are not damaged by fluid from the injector.

In another aspect, the tree injection device includes a piston slidably received within a cylinder to define a piston chamber and a rack chamber therein, a reservoir in fluid communication with the piston chamber, wherein a first check valve allows fluid to pass from the reservoir to the piston chamber while substantially preventing fluid from passing from the piston chamber to the reservoir, an injector in fluid communication with the piston chamber, the injector being adapted for insertion into a tree, wherein a second check valve allows fluid to pass from the piston chamber to the injector, while substantially preventing fluid from passing from the injector to the piston chamber and a motor operatively connected to the piston by a rack and a gear assembly such that a rotational force of the motor is translated into displacement of the piston within the cylinder, wherein displacement of the piston in a first direction corresponds to a drawing of a fluid from the reservoir into the piston chamber and displacement of the piston in a second direction corresponds to a purging of the fluid from the piston chamber to the injector.

In another aspect, the tree injection device provides a method for injecting a tree with a fluid including the steps of providing a piston slidably received with a cylinder, the piston defining a piston chamber and a rack chamber within the cylinder, wherein the piston chamber is in one-way fluid communication with a fluid reservoir and in one-way fluid communication with an injector, drawing a fluid from the fluid reservoir into the piston chamber by withdrawing the piston from the cylinder and ejecting the fluid from the piston chamber to the injector by advancing the piston through the cylinder.

Other aspects of the tree injection device will become apparent from the following detailed description, the accompanying drawing and the appended claims.

### BRIEF DESCRIPTION OF THE DRAWING

FIG. 1 is a front perspective view of one aspect of the of the tree injection device.

### DETAILED DESCRIPTION

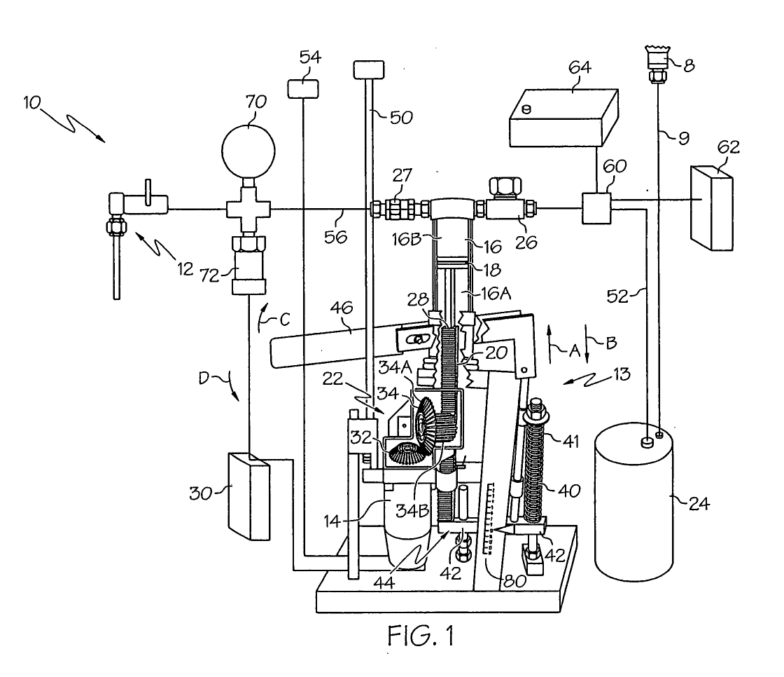

As shown in FIG. 1, a first aspect of the tree injection device, generally designated 10, may include an injector 12, a fluid reservoir 24, check valves 26, 27 and a displacement pump assembly 13. The displacement pump assembly may include a motor 14, a cylinder 16, a piston 18, a rack 20 and a gear assembly 22. The piston 18 may be slidably received within the cylinder 16 to define a piston chamber 16B and a rack chamber 16A within the cylinder 16.

Various fluids, such as growth retardants or regulators, fertilizers, fungicides, insecticides, herbicides, pesticides and the like, may be stored in the reservoir 24 and transferred to the injector 12 by the displacement pump assembly 13 such that the fluids may be injected into a tree. The reservoir 24 may be replenished with additional fluid by a pressurized source 8 and pressurized supply line 9. In one aspect, the reservoir 24 may be a tank, a bucket or the like and may be constructed from a polymeric material, a metallic material or other like material and may be selected such that the reservoir 24 does not react with the contents being stored in the reservoir 24.

The injector 12 may be a needle, a hollow rod or the like and may be adapted to be inserted into the a tree (e.g., the trunk of a tree) to allow fluid to pass therethrough. In one aspect, the injector 12 may include threads or ridges adapted to allow the injector to be inserted (e.g., screwed) into a tree, while preventing the injector from being unintentionally removed from the tree. In another aspect, the injector 12 may be hammered into the trunk of a tree.

The piston 18 may be connected to the motor 14 by a gear assembly 22. The gear assembly 22 may include a beveled gear member 32, an intermediate gear member 34 having a first gear 34A and a second gear 34B, and the rack 20. The beveled gear member 32 may be fixedly connected to the shaft (not shown) of motor 14 and may mesh with the first gear 34A of the intermediate gear member 34. The second gear 34B of the intermediate gear member 34 may mesh with the teeth of the rack 20. The piston 18 may be fixedly connected to a distal end 28 of the rack 20.

Accordingly, the gear assembly 22 may translate rotational power from the motor 14 into forward (i.e., distally advancing) movement of the piston 18 in the direction shown by arrow A.

The motor 14 may be connected to a power source 30, such as a 12-volt battery. The power source 30 may be a direct current power source or an alternating current power source. A switch 54 may be provided for initiating and stopping the motor 14. In one aspect, when the motor 14 is stopped, movement of the gear assembly 22 also stops such that the position of the piston 18 within the cylinder 16 remains fixed until the motor 14 is reinitiated or the piston 18 is manually withdrawn from the cylinder 16 (i.e., is urged in the direction shown by arrow B). In another aspect, the position of the piston 18 within the cylinder 16 may be fixed using an anti-reverse motor. Alternatively, an anti-reverse gear assembly, a ratcheting pall adapted to engage the teeth of the rack 20 or any other anti-reverse mechanism may be used.

Rack 20 and corresponding piston 18 may be biased to the withdrawn position (i.e., in the direction shown by arrow B) by a spring 40. The spring 40 may be coaxially received over a spring support rod 41 to urge a lower bar 42, which is connected to the rack 20 at connection point 44, in the direction shown by arrow B, thereby biasing the piston 18 out of the cylinder 16.

A gear disconnecting assembly 50 may be attached to the gear assembly 22 such that when the gear disconnecting assembly 50 is actuated, the beveled gear 32 disengages the first gear 34A of the intermediate gear member 34, thereby allowing the energy of spring 40 (when it has been compressed due to advancement of the piston 18) to force the rack 20, and corresponding piston 18, in the direction shown by arrow B. When the gear disconnecting assembly 50 is released, the beveled gear 32 may again engage the first gear 34A of the intermediate gear member 34, thereby reconnecting the motor 14 to the piston 18. Alternatively, gear disconnecting assembly 50 may be a clutch (not shown) between the shaft of the motor 14 and the beveled gear 32 such that when the gear disconnect assembly 50 is actuated, the beveled gear 32 is disconnected from the shaft of the motor 14 and no power is transferred to the piston 18. Still alternatively, assembly 50 may be any mechanism adapted to disengage and/or disconnect the anti-reverse mechanism of gear assembly 22.

A lever 46 may be provided to manually advance the piston 18 into the cylinder 16 for purging air from the cylinder 16. The lever 46 may be connected to the lower bar 42 such that when the gear disconnecting assembly 50 is actuated (i.e., beveled gear 32 is disconnected from intermediate gear 34) and the lever 46 is urged in the direction shown by arrow D, the lower bar 42 advances in the forward direction (shown by arrow A), against the force of spring 40, thereby advancing piston 18 into cylinder 16.

The reservoir 24 may be in fluid communication with the piston chamber 16B of the cylinder 16 by way of supply line 52. A check valve 26 may be provided intermediate of the reservoir 24 and the cylinder 16 to allow fluid to pass from the reservoir 24 to the piston chamber 16B of the cylinder 16, while preventing fluid in the piston chamber 16B of the cylinder 16 from returning to the reservoir 24.

Accordingly, fluid from the reservoir 24 may be drawn into the cylinder 16 as follows: the piston 18 may be fully advanced into the cylinder 16 using lever 46, as discussed above, to purge the air from the piston chamber 16B; the lever 46 may then be urged in the direction shown by arrow C, thereby withdrawing the piston 18 from the cylinder 16 and creating a vacuum in the piston chamber 16B, which draws fluid from reservoir 24, through supply line 52, past the check valve 26 and into the piston chamber 16B.

The injector 12 may be in fluid communication with the piston chamber 16B of the cylinder 16 by supply line 56. A check valve 27 may be positioned intermediate of the injector 12 and cylinder 16 to allow fluid to pass from the piston chamber 16B to the injector 12, while preventing fluid from returning to the piston chamber 16B.

Accordingly, fluid drawn into the cylinder 16, as described above, may be expelled through injector 12 as follows: the motor 14 may be initiated using switch 54, thereby causing the gradual advance of piston 18 through cylinder 16. A motor speed may be selected according the requirements of specific tasks. As the piston 18 advances, the fluid in the cylinder 16 may be forced out of the cylinder 16 and into the supply line 56 where check valve 26 prevents the fluid from returning to the reservoir 24, while check valve 27 allows the fluid to pass to the injector 12 such that the fluid may be injected into a tree (not shown).

In an alternative aspect, a flow meter 60 may be positioned on the supply line 52 to monitor the amount of fluid moving from the reservoir 24 to the cylinder 16. The flow meter 60 may be connected to a power source 62, such as a battery, and a counter 64. The counter 64 may total the amount of fluid that has been transferred from the reservoir 24 to the cylinder 16.

In another alternative aspect, a pressure gauge 70 and an adjustable pressure switch 72 may be provided on the supply line 56 for measuring the pressure of the fluid being injected into the tree and for controlling the increase in pressure in the supply line 56. The pressure in the supply line 56 may continually increase as the piston 18 continues to advance and force fluid into the supply line 56 due to the resistance or backpressure (i.e., the tree's resistance to the uptake of fluid) of the tree.

Thus, the adjustable pressure switch 72 may be connected to the motor 14 and the power source 30 and preset to a certain maximum pressure such that when the gauge 70 determines that the preset maximum pressure in the supply line 56 has been achieved, the adjustable pressure switch 72 may cut off power to the motor 14, thereby stoping the advance of the piston 18 and corresponding increase in pressure. When the gauge 70 determines that the pressure in the supply line 56 has dropped below the preset maximum, the adjustable pressure switch 72 may restore power to the motor 14 such that piston 18 may again begin to pump fluid through the supply line 56.

In another alternative aspect, the tree injection device 10 may include an auto shut-off assembly such that, as the piston 18 advances to its furthest position within the cylinder 16, the motor 14 is automatically shut off. The auto shut-off assembly may include a setscrew (not shown) positioned on the rack 20 such that when the rack 20 is advanced to a certain position, the setscrew trips a switch that cuts off the power to the motor 14.

In another alternative aspect, the tree injection device 10 may include a fluid measuring mechanism 80 that controls the distance that the piston 18 is retracted when the spring retracts piston 18 in the direction shown by arrow B, and hence the amount of fluid that is drawn into the cylinder 16 (i.e., the dosage). The fluid measuring mechanism 80 may include a setscrew that may be adjusted to various positions to prevent the piston 18 from being retracted past a certain point. The fluid measuring mechanism 80 may be capable of accurately measuring dosages as small as about 1 ml, and, in one aspect, dosages ranging from about 1 ml to about 50 ml.

In one aspect, the tree injection device 10 may be operated as follows. The cylinder 16 may be purged of air by actuating the gear disconnecting assembly 50 and urging the lever 46 in the direction shown by arrow D such that the piston 18 is advanced to its furthest position (i.e., in the direction shown by arrow A). The piston 18 may then be retracted (i.e., in the direction shown by arrow B) by urging the lever 46 in the direction shown by arrow C such that fluid from the reservoir 24 may drawn into the piston chamber 16B of the cylinder 16 until a certain dosage of fluid is obtained. The gear disconnecting assembly 50 may then be released and the motor 14 may be initiated by switch 54 such that the piston 18 may begin to slowly advance in the direction shown by arrow A. As the piston 18 advances, the fluid in the cylinder 16 may be urged into the supply line 56, through the injector 12, and into a tree. The slow advance of the piston 18 may create a variable pressure system, wherein the fluid pressure only increases to the extent necessary to overcome the resistance (or backpressure) in the tree.

The adjustable pressure switch 72 may continuously monitor the pressure within the supply line 56 such that when a maximum preset pressure is detected in the supply line 56, the adjustable pressure switch 72 may cut off power to the motor 14, thereby stopping the advance of the piston 18 and further accumulation of pressure. Once the pressure in the supply line 56 drops to below the maximum preset pressure (or a preset minimum pressure), the adjustable pressure switch 72 may restore power to the motor 14, thereby resuming the advance of the piston 18 and corresponding flow of fluid through the supply line 56 and into the tree.

Although the tree injection device is shown and described with respect to certain aspects, modifications will occur to those skilled in the art upon reading and understanding the specification. The tree injection device includes all such modifications and is limited only by the scope of the claims.

1. A tree injection device comprising:
a piston slidably received within a cylinder to define a piston chamber and a rack chamber within said cylinder;
a reservoir in fluid communication with said piston chamber, said reservoir including a first check valve adapted to allow fluid to flow from said reservoir to said piston chamber while substantially preventing fluid from passing from said piston chamber to said reservoir;
an injector in fluid communication with said piston chamber, said injector being adapted for insertion into a tree, said injector including a second check valve adapted to allow fluid to pass from said piston chamber to said injector while substantially preventing fluid from passing from said injector to said piston chamber; and
a drive motor assembly including a rack operatively connected to said piston to advance said piston through said cylinder, whereby movement of said piston by said drive motor provides a gradual increase in pressure such that cells of a tree are not damaged by fluid from said injector.

2. The tree injection device of claim 1 wherein said reservoir is adapted to store a fluid selected from the group consisting of growth retardant solutions, growth regulator solutions, fertilizer solutions, fungicide solutions, insecticide solutions, herbicide solutions and pesticide solutions.

3. The tree injection device of claim 1 further comprising a pressurized fluid source for supplying said reservoir with a fluid.

4. The tree injection device of claim 1 wherein said injector is a needle.

5. The tree injection device of claim 1 wherein said injector includes threads or ridges adapted to engage a tree.

6. The tree injection device of claim 1 wherein said motor is operatively connected to said piston by a gear assembly and a rack.

7. The tree injection device of claim 1 further comprising an anti-reverse mechanism adapted to maintain said piston at a fixed position relevant to said cylinder when said motor is in an inactive state.

8. The tree injection device of claim 7 wherein said anti-reverse mechanism is an anti-reverse motor.

9. The tree injection device of claim 1 further comprising a flow meter positioned between said reservoir and said piston chamber, said flow meter being adapted to measure the amount of fluid passing from said reservoir to said piston chamber.

10. The tree injection device of claim 1 wherein a fluid line connects said injector with said piston chamber.

11. The tree injection device of claim 10 further comprising a pressure gauge positioned on said fluid line to monitor a pressure of a fluid within said fluid line.

12. The tree injection device of claim 11 further comprising a pressure switch in communication with said pressure gauge, said pressure switch being adapted to control said motor based on data obtained from said pressure gauge.

13. The tree injection device of claim 1 further comprising a fluid measuring device, said fluid measuring device being adapted to limit the displacement of said piston within said chamber thereby limiting the amount of fluid capable of being drawn into said piston chamber.

14. A tree injection device comprising:
a piston slidably received within a cylinder to define a piston chamber and a rack chamber therein;
a reservoir in fluid communication with said piston chamber, said reservoir including a first check valve adapted to allow fluid to pass from said reservoir to said piston chamber while substantially preventing fluid from passing from said piston chamber to said reservoir;
an injector in fluid communication with said piston chamber, said injector being adapted for insertion into a tree and including a second check valve adapted to allow fluid to pass from said piston chamber to said injector, while substantially preventing fluid from passing from said injector to said piston chamber; and
a motor operatively connected to said piston by a rack and a gear assembly such that a rotational force of said motor is translated into displacement of said piston within said cylinder,
wherein displacement of said piston in a first direction corresponds to a drawing of a fluid from said reservoir into said piston chamber and displacement of said piston in a second direction corresponds to a purging of said fluid from said piston chamber to said injector.

15. The tree injection device of claim 14 wherein a fluid line connects said injector with said piston chamber.

16. The tree injection device of claim 15 further comprising a pressure gauge positioned on said fluid line to monitor a pressure of said fluid within said fluid line.

17. The tree injection device of claim 16 further comprising a pressure switch in communication with said pressure gauge, said pressure switch being adapted to control said motor based on data obtained from said pressure gauge.

18. The tree injection device of claim 14 wherein said fluid is selected from the group consisting of growth retardant solutions, growth regulator solutions, fertilizer solutions, fungicide solutions, insecticide solutions, herbicide solutions and pesticide solutions.

19. A method for injecting a tree with a fluid comprising the steps of:
providing a piston slidably received with a cylinder, said piston defining a piston chamber and a rack chamber within said cylinder, wherein said piston chamber is in one-way fluid communication with a fluid reservoir and in one-way fluid communication with an injector;
drawing a fluid from said fluid reservoir into said piston chamber by displacing said piston within said cylinder in a first direction; and
ejecting said fluid from said piston chamber to said injector by displacing said piston within said cylinder in a second direction opposite of said first direction.

20. The method of claim 19 further comprising the step of connecting said injector to a tree.
